(19) United States
(12) Patent Application Publication
(10) Pub. No.: US 2008/0201966 A1
(43) Pub. Date: Aug. 28, 2008

(54) Razor Handle Provided with an Improved Grip

(75) Inventors: Yiannis Psimadas, Vrilissia-Athens (GR); Spiros Gratsias, Kypseli-Athens (GR); Dimitris Efthimiadis, Nea Kypseli-Athens (GR)

Correspondence Address: JONES DAY, 222 EAST 41ST ST, NEW YORK, NY, 10017, US

(73) Assignee: BIC-VIOLEX SA, Anixi (GR)

(21) Appl. No.: 11/994,230

(22) PCT Filed: Jun. 28, 2005
(86) PCT No.: PCT/EP05/07900

§ 371 Date: Dec. 28, 2007

(51) Int. Cl. B26B 21/52

(52) U.S. Cl. 30/526

(57) ABSTRACT

A razor handle with an improved grip surface having a rigid plastic part and a compressible part. The razor handle also includes a plurality of bumps that are located on the rear part of the handle. The plurality of bumps protrude above the rigid plastic part of the handle.

### CROSS-REFERENCE TO RELATED APPLICATIONS

This application is a national stage application of International application No. PCT/EP2005/007900, filed on Jun. 28, 2005, the entire contents of which are incorporated herein by reference.

### BACKGROUND OF THE INVENTION

1. Field of the Invention

Embodiments of the present invention relate to a wet or safety razor. Embodiments of the present invention particularly relate to an ergonomic handle provided with an improved grip structure for a wet or safety razor.

2. Description of the Related Art

Many types of wet or safety razors (referred hereinafter as safety razors) are known in the art. Razors usually comprise a handle portion, at the front end of which a razor blade unit comprising one or more blades is disposed.

The structure of the handle portion is important in order to provide an optimal gripping position, thereby resulting in an optimal shaving angle to the one or more blades with respect to the surface of skin. Typically, gripping pads or ribs are provided on the surface of the handles.

However, many known types of handles are limited in their gripping properties when the handle is used in a wet and soapy environment. Thus, although the gripping pads or ribs are made from an elastomeric compressible material, their shape and/or size do not facilitate shaving, particularly precision shaving, and more particularly when the index finger of the user guides the razor blade unit. It has been noted by the Applicants that when a user holds the handle according to the so-called “flute” or “spoon” or “shovel” or “feather” or “pen” grip, only a few surfaces of the handle are in contact with the user's hand and are essential for a safe grip, including the top of the rear part of the handle.

Although some known types of handles make it possible to obtain good gripping, research is still ongoing into handles with even better qualities, particularly with regards to precision shaving and more particularly when the user holds the handle in accordance with the so-called “flute” or “spoon” or “shovel” or “feather” or “pen” grip.

World Intellectual Property Organization Publication No. WO 2004/018163 is directed to a shaver handle comprising an elongated rigid inner core extending along a longitudinal axis and an elongated, compressible outer layer formed around the inner rigid core, the compressible outer layer being provided with a series of axially spaced fins having a substantially uniform aspect ratio D:T, wherein D is a depth of each individual fin viewed in a direction transverse to the longitudinal axis and T is a thickness of the individual fin viewed in a direction parallel to the longitudinal axis, the aspect ratio being greater than the depth D of the individual fin. The top of the compressible outer layer formed around the inner rigid core can have include various small numerous small projections.

### SUMMARY OF THE INVENTION

Applicants have designed new types of handles include rubber bumps on the upper side of the handle at the rear part of the handle.

It has been noted in a surprising and unexpected fashion that the use of the new type of handles of the present invention allows the razor blade unit to be precisely guided with the result being that a very good shave is obtained on difficult surfaces of the skin such as under the nose or close to the ears.

Accordingly, embodiments of the present invention are therefore directed to a handle having an improved grip structure for a wet or safety razor, comprising a rigid plastic part and a compressible part wherein the handle comprises rubber bumps provided on the upper side of the handle in the rear part of the handle and wherein said rubber bumps protrude above a rigid plastic surface of the handle.

### BRIEF DESCRIPTION OF THE DRAWINGS

FIG. 1 is a top plan view of the back half part of a safety razor in accordance with one embodiment of a handle of the present invention; and

FIG. 2 is a side elevation view of the rear half part of a handle of a safety razor in accordance with one embodiment of a handle of the present invention.

### DESCRIPTION

As used herein, the term “rubber” preferably relates to an elastomeric plastic material, more preferably a mouldable elastomeric material, allowing for ample compression by the user without the need for an excessive force. Examples of such materials are, for example, any elastomeric composition known in the art and of any elastomeric hardness range, especially those suitable for making a grip portion, and those that are in the Shore A hardness range. These include elastomers and thermoplastic elastomers, as well as blends thereof. Suitable elastomers include, but are limited to, nitrile rubbers (NBR), styrene butadiene rubbers (SDR), ethylene-propylene 5 terpolymers (EPDM), and (compatible) mixtures thereof. Examples of suitable thermoplastic elastomers include styrene block copolymers, e.g. styrene-butylene block copolymers (SBS), styrene-ethylene-butylene block copolymers (SEBS), thermoplastic polyurethanes, polyether block amides, copolyesters, thermoplastic polyolefins (EPDM/PP, NBR/PP, etc.), and (compatible) blends thereof. Moreover, the elastomeric material may contain one or more additives. Examples of such additives include chemicals commonly classed as antioxidants, UV-stabilisers, adhesion modifiers, smell reducers and other such materials that are known to those skilled in the art. Additives improve the processing of the material, enhance its shelf-life and service durability, improve the adhesion to substrate “polymeric supports” that are not inherently inter-compatible, and delay inherent sensory defects such as the inherent smell typically associated with elastomers and elastomeric compounds.

By “in the rear part of the handle,” it is meant that the rubber bumps are provided less than 6.5 cm from the rear of the handle, preferably between 6 cm and 1 cm, more preferably between 4.5 cm and 1.2 cm, and even more preferably between 2.7 cm and 1.3 cm. The distances disclosed above are calculated from the centre of the bumps.

In one embodiment of the present invention, the transverse cross-section of the handle is generally V-shaped for more than 30% of the length of the handle, preferably more than 50%, more preferably more than 70%, and even more preferably for approximately the entire length of the handle.

The number of rubber bumps is, for example, from 4 to 35, preferably 6 to 20, more preferably 8 to 16, and even more preferably 9 to 11.

Though the rubber bumps may have any suitable shape, for example, cubic or frustoconical, in other embodiments, the rubber bumps may be hemispherical. The above designs are suitable particularly in view of the demoulding of the handle, if prepared by moulding operations. Additionally, substantially hemispherical-shaped bumps provide the best gripping effect.

The height of the rubber bumps may be constant or the height of the rubber bumps may progressively increase from a smaller height at the back or rear end of the handle, to a greater height towards the blades or front end of the handle. Conversely, the rubber bumps may progressively increase from the front end of the handle where the blades are disposed, towards the back or rear end of the handle. The height of the rubber bumps may be, for example, from 0.2 to 2.0 mm, preferably 0.4 to 1.5 mm, and more preferably 0.6 to 0.8 mm above the rigid plastic surface.

The spacing between two adjacent rubber bumps may be, for example, from 10 to 2 mm, preferably 7.0 to 2.5 mm and more preferably 5.0 to 3.0 mm. The width (or diameter for the hemispherical or like-shaped bumps) of a rubber bump may be, for example, from 0.5 to 4.0 mm, preferably 0.7 to 3.0 mm and more preferably 1.0 to 2.0 mm.

The slipping prevention effect provided by the above rubber bumps is enhanced by the contrast between the rigid plastic material, for example, polypropylene, or ABS resin, on which the bumps are provided, and the rubber or elastomeric material of the bumps such as, for example, ADSTIFF® 840 or 648 grades commercially available from BASEL's.

The handle of embodiments of the present invention has a composite structure comprising a substantially rigid backbone of an injected moulded thermoplastic, non elastomeric material and a flexible part made of an injection moulded elastomeric material. Some portions on the surface of the handle are comprised of the non elastomeric material and the other portions are comprised of the elastomeric material. As regards the rear half part of the top of the handle, preferably more than 50%, more preferably more than 60%, and even more preferably more than 70% of the surface is made of rigid plastic material.

Still, as regards the rear half part of the top of the handle, preferably from 2% to 30%, more preferably from 5% to 30%, and even more preferably from 5% to 20% of the surface is made of elastomeric material.

In one embodiment, the present handle is obtained using a two step process. The method for making a razor handle as disclosed above comprises moulding a backbone portion of a rigid plastic material and moulding an elastomeric grip portion on the backbone portion, wherein rubber bumps are provided on the upper side of the rear portion of the handle.

According to another embodiment of the present invention, channels are provided on the backbone portion of the handle at the rear end/or part of the handle such that the desired rubber bumps may be created by feeding the elastomeric material from below the plastic rigid surface, through the channels and through holes opened on the upper surface of the handle. Rubber bumps provided on the rigid plastic top surface of the rear part of the handle are thus obtained.

Thus, the handles according to embodiments of the present invention are advantageous because of the rubber bumps provided on the rear upper side of the handle.

Six major gripping positions have been identified and are as follows (1) the “pen” position wherein the handle is grasped like a pen while the top of the rear part of the handle rests on the palm of the user; (2) the “pincer” position wherein the front part of the handle is gripped between the thumb and the index finger, while the top of the rear part of the handle rests on the palm of the user; (3) the “feather” position wherein the front part of the handle is surrounded by four fingers while the top of the rear part of the handle rests on the palm of the user; (4) the “flute” position wherein the handle is grasped like a pan-pipe; (5) the “spoon” position wherein the handle is grasped like a spoon; and (6) the “shovel” position wherein the handle is grasped between the thumb resting under the handle and the four other fingers resting along the top of the handle.

For all the gripping positions the bumps of the present invention prevent the palm or fingers of a user's hand from slipping, particularly during precision shaving. The present bumps rest on the palm of the user's hand for the first three gripping positions, rest on the distal phalanx of the ring and little finger for the “flute” position, rest on the proximal phalanx of the index finger for the “spoon” position, and rest on the distal phalanx of the index finger for the “shovel” position.

Also, a handle such as that disclosed above with the arrangement of rubber bumps shaped and dimensioned as described above, provides the user with an improved tactile feel as well.

A safety razor having a handle, which is shaped as described above, ensures an optimal ergonomic grip by the user during precision shaving.

Preferred embodiments for implementing the rubber bumps disclosed above also apply to the other subjects of the invention envisaged above, particularly to the method for making a razor handle as disclosed above.

The scope of the invention can be understood better by referring to the description of the figures that follows, the aim of which is to explain the advantages of the invention.

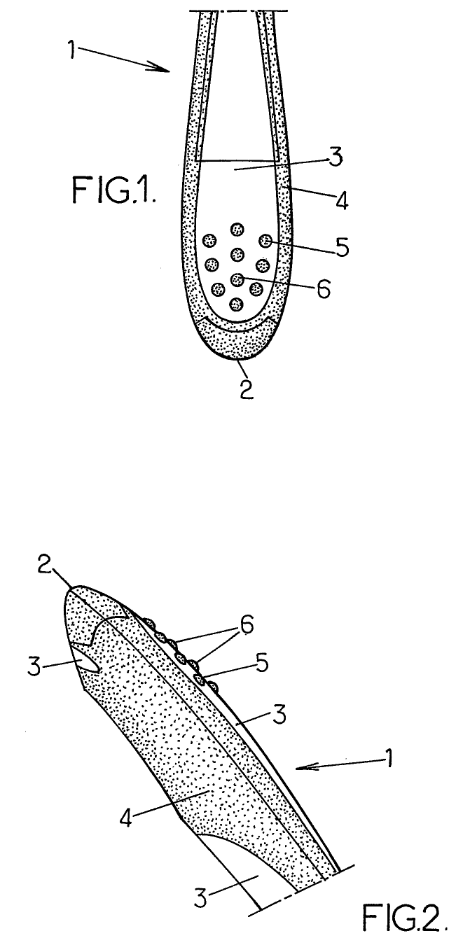

As depicted in FIG. 1, a safety razor according to an embodiment of the present invention includes a gently curved handle 1. The handle 1 has an elongated body portion for hand grasping by a user, the back part of which is represented in FIG. 1. The whole handle 1 has a length of about 12 cm as measured along its body between the front end (not represented) and the back end 2. The handle comprises a backbone 3 made of a mouldable rigid plastic material, and a partial layer of mouldable elastomeric material 4 allowing for compression by the user without the need of an excessive force. Surface shading on the figures indicates the portions of the handle 1 made of the mouldable elastomeric material 4.

In one embodiment, ten rubber bumps 5,6 are provided towards the rear of the handle on the top surface thereof. Four bumps 6 are aligned according to a symmetry longitudinal axis of the handle and six further bumps 5 are provided according to a curve on each side of the alignment of the central bumps. The rubber bumps 5,6 are made from the above disclosed mouldable elastomeric material.

As seen in FIG. 2, the general shape of the bumps 5,6 is hemispherical. The top surface of the handle is gently curved.

The razor is optimally guided by the palm of the user during shaving.

1-11. (canceled)

12. A razor handle with an improved grip structure comprising:
a rigid plastic part;
a compressible part; and
a plurality of bumps disposed on an upper side of a rear part of the handle,
wherein the plurality of bumps protrude above the rigid plastic part of the handle.

13. The razor handle according to claim 1, wherein the plurality of bumps are rubber.

14. The razor handle according to claim 1, wherein the plurality of bumps are located between 1.0 cm and 6.0 cm from the rear part of the handle.

15. The razor handle according to claim 1, wherein a transverse cross-section of the razor handle is generally V-shaped for more than approximately 30% of the length of the razor handle.

16. The razor handle according to claim 1, wherein the number of the plurality of bumps ranges from 6 to 20.

17. The razor handle according to claim 1, wherein a shape of the plurality of bumps is selected from the group consisting of cubic, frustoconical and hemispherical.

18. The razor handle according to claim 1, wherein a height of the plurality of bumps is constant.

19. The razor handle according to claim 1, wherein a height of the plurality of bumps is between 0.4 mm to 1.5 mm above the rigid plastic part.

20. The razor handle according to claim 1, wherein a spacing between two adjacent bumps ranges from 2.5 mm to 7.0 mm.

21. The razor handle according to claim 1, wherein a width of a bump ranges from 0.7 mm to 3.0 mm.

22. The razor handle according to claim 1, wherein more than 50% of the upper side of the rear part of the razor handle is made of rigid plastic material.

23. The razor handle according to claim 1, wherein from 2% to 30% of a surface of the upper side of the rear part of the razor handle is made of elastomeric material.

24. A razor handle having a front end portion, a rear end portion, a top surface and a bottom surface, the razor handle comprising:
a rigid plastic portion having a rigid plastic surface;
an elastomeric material portion; and
a plurality of protuberances protruding above the surface of the rigid plastic portion, wherein each protuberance has a height and a width, and
wherein the rear end portion of the razor handle includes both a rigid plastic portion and an elastomeric material portion.

25. The razor handle according to claim 24, wherein more than 50% of the top surface of the rear end portion of the razor handle comprises the rigid plastic material.

26. The razor handle according to claim 24, wherein approximately 2% to 30% of the top surface of the rear end portion of the razor handle comprises the elastomeric material.

27. The razor handle according to claim 24, wherein a shape of the plurality of protuberances is selected from the group consisting of cubic, frustoconical and hemispherical.

28. The razor handle according to claim 24, wherein the height of the plurality of protuberances is constant.

29. The razor handle according to claim 24, wherein the height of the plurality of protuberances increases from a smaller height at the rear end portion of the razor handle to a larger height towards the front end portion of the razor handle.

30. The razor handle according to claim 24, wherein the height of the plurality of protuberances increases towards the rear end portion of the razor handle.

31. A razor comprising:
a razor handle comprising
a front end portion;
a rear end portion;
a top surface;
a bottom surface;
a rigid plastic portion having a rigid plastic surface;
an elastomeric material portion; and
a plurality of protuberances protruding above the surface of the rigid plastic portion, wherein each protuberance has a height and a width, and
wherein the rear end portion of the razor handle includes both a rigid plastic portion and an elastomeric material portion; and
a razor blade unit including at least one razor blade,
wherein the razor blade unit is disposed at the front end portion of the razor handle.
